(19) United States
(12) Patent Application Publication
(10) Pub. No.: US 2019/0190003 A1
(43) Pub. Date: Jun. 20, 2019

(54) PROCESS FOR MANUFACTURING A STRUCTURE ACTING AS A POSITIVE ELECTRODE AND AS A CURRENT COLLECTOR FOR A LITHIUM-SULFUR ELECTROCHEMICAL ACCUMULATOR

(71) Applicant: COMMISSARIAT À L'ÉNERGIE ATOMIQUE ET AUX ÉNERGIES ALTERNATIVES, Paris (FR)

(72) Inventors: Céline Barchasz, Fontaine (FR); Marco Bolloli, Grenoble (FR); Rémi Vincent, Grenoble (FR)

(21) Appl. No.: 16/309,721

(22) PCT Filed: Jun. 16, 2017
(86) PCT No.: PCT/FR2017/051586

§ 371 Date: Dec. 13, 2018

(30) Foreign Application Priority Data
Jun. 17, 2016 (FR) 16 55661

(51) Int. Cl. H01M 4/133; H01M 4/04; H01M 4/1393; H01M 10/0525; H01M 4/62

(52) U.S. Cl. CPC H01M 4/133; H01M 4/0471; H01M 4/0409; H01M 2004/028; H01M 10/0525; H01M 4/0414; H01M 4/625; H01M 4/1393

(57) ABSTRACT

A process for preparing a structure acting both as a positive electrode for a lithium-sulfur battery and as a current collector, comprising the following operations: depositing one or more liquid compositions comprising the constituent ingredients of this structure on a removable substrate; drying the one or more deposited compositions; separating the removable substrate from the structure thus obtained, which forms the structure acting both as a positive electrode for a lithium-sulfur battery and as a current collector.

### TECHNICAL FIELD

The present invention relates to a process for preparing a structure acting as a positive electrode and a current collector for a lithium-sulphur electrochemical accumulator.

The present invention also relates to a lithium-sulphur electrochemical accumulator comprising such a structure.

The general field of the invention can thus be defined as that of energy storage devices, in particular that of lithium electrochemical accumulators and, even more particularly, lithium-sulphur electrochemical accumulators.

### STATE OF PRIOR ART

Energy storage devices are conventionally electrochemical accumulators operating on the principle of electrochemical cells able to deliver an electric current by thanks to the presence in each of them of a couple of electrodes (respectively, a positive electrode and a negative electrode) separated by an electrolyte, the electrodes comprising specific materials able to react according to an oxidation-reduction reaction, whereby there are a production of electrons originating the electric current and productions of ions which will circulate from one electrode to the other through an electrolyte.

The most currently used accumulators operating on this principle are the following ones:

Ni-MH accumulators using metal hydride and nickel oxyhydroxide as electrode materials;

Ni—Cd accumulators using cadmium and nickel oxyhydroxide as electrode materials;

acid-lead accumulators using lead and lead oxide PbO₂ as electrode materials; and

lithium accumulators, such as lithium-ion accumulators, conventionally using, in all or part, lithium materials as electrode materials.

Because lithium is a particularly light solid material and has the lowest electrochemical potential, thus allowing access to an interesting mass energy density, lithium accumulators widely superseded the other accumulators mentioned above because of the continuous improvement in the performances of the Li-ion accumulators in terms of energy density. Indeed, lithium-ion accumulators enable much higher mass and volume energy densities (that today can reach approximately 200 Wh.kg⁻¹) than those of Ni-MH and Ni—Cd accumulators (that can range from 50 and 100 Wh.kg⁻¹) and acid-lead accumulators (that can range from 30 to 35 Wh.kg⁻¹) to be obtained. What is more, Li-ion accumulators can have a cell nominal voltage higher than that of other accumulators (for example, a nominal voltage in the order of 3.6 V for a cell implementing as electrode materials the LiCoO₂/graphite couple versus a nominal voltage in the order of 1.5 V for the other abovementioned accumulators). The energy density is about 300 to 500 Wh.l⁻¹ and 160 to 200 Wh.kg⁻¹. These systems also have a low self-discharge and a high lifetime (ranging from 500 to 1000 cycles, for example).

Because of their intrinsic properties, Li-ion accumulators thus turn out to be particularly interesting for fields where autonomy is an essential criterion, as is the case in the field of computer science, video, telephony, transports such as electric vehicles, hybrid vehicles, or even medical, spatial, microelectronic fields. However, the technology of lithium-ion accumulators is today reaching its limits.

Currently, a new lithium-based accumulator technology arises as a promising alternative, this technology being the lithium/sulphur technology, in which the positive electrode comprises, as an active material, elemental sulphur or a sulphur derivative, such as lithium-sulphide or a polylithium-sulphide.

The use of sulphur, as an active material, for a positive electrode is particularly attractive, because sulphur has a very high theoretical specific capacity that can be up to more than 10 times higher than that obtained for conventional materials of positive electrode (in the order of 1675 mAh/g instead of 140 mAh/g for LiCoO₂). What is more, sulphur is abundantly present on the planet and is characterised, therefore by low costs. Finally, it is poorly toxic. All these qualities contribute to make it particularly attractive in view of a large-scale use, in particular for electric vehicles, in particular as lithium/sulphur accumulators can enable mass energy densities that can range from 300 to 600 Wh.g⁻¹ to be reached.

From a functional point of view, the reaction originating current production (that is when the accumulator is in a discharging mode) involves a lithium oxidation reaction at the negative electrode which produces electrons, which will supply the external circuit to which the positive and negative electrodes are connected, and a sulphur reduction reaction at the positive electrode.

Thus, explicitly, in a discharging process, the overall reaction is the following one:

S₈+16Li→8Li₂S

which is the sum of the sulphur reduction reaction at the positive electrode (S₈+16e⁻→8S²⁻) and the lithium oxidation reaction at the negative electrode (Li→Li⁺₊e⁻).

Of course, the reverse electrochemical reactions occur during the charging process.

As is clear from the equation above, the reaction involves an exchange of 16 electrons, which explains the high sulphur specific capacitance (1 675 mAh.g⁻¹).

From a mechanistic point of view, and without wishing to be bond by theory, in the initial state (that is when the battery is in the full charge state), the active material, which is elemental sulphur, is present in the solid state in the positive electrode. During the sulphur reduction, that is during discharge, cyclic sulphur molecules are reduced and form linear lithium polysulfide chains, of the general formula Li₂Sₙ, with n possibly ranging from 2 to 8. Since the starting molecule is S₈, the first compounds being formed are long-chain lithium polysulfides, such as Li₂S₈ or Li₂S₆. Since these lithium polysulfides are soluble in organic electrolytes, the first discharging step thus consists in solubilising the active material in the electrolyte, and producing long-chain lithium polysulfides in solution. Then, as the sulphur reduction continues, the length of the polysulfide chain is gradually reduced, and compounds such as Li₂S₅, Li₂S₄ or even Li₂S₂ are formed in solution. Finally, the final reduction product is lithium-sulfide (Li₂S) which, in turn, is insoluble in organic electrolytes. Thus, the last step of the sulphur reduction mechanism consists in precipitating the sulphur active material.

This mechanism can be correlated with the discharging profile illustrated in FIG. 1, which represents a graph illustrating the potential E (in V) as a function of the capacity C (in a.u).

Indeed, in this profile, the first plateau can be assigned to the formation of long lithium polysulfide chains, whereas the second plateau corresponds to the reduction of the sulphur chain size, until the positive electrode is passivated.

However, lithium-sulphur accumulators have a number of drawbacks.

The first limitation is of the kinetic type, since sulphur is an insulating material. Sulphur is also soluble in the organic electrolytes employed. Thus solubilised, it can contribute to generate corrosion of the lithium negative electrode and is responsible for the significant self-discharge of lithium-sulphur accumulators.

Intermediate polysulfides are also soluble in the electrolyte and likely to react with the negative electrode. Thus, they also promote self-discharge of the accumulator. Further, they are responsible for the occurrence of a shuttle mechanism which appears during charging, and which causes degradation of the accumulator performance, in particular in terms of columbic efficiency. Finally, the discharge product Li₂S is, in turn, insoluble in the electrolyte and electron insulating. Therefore, it precipitates at the end of discharge and passivates the surface of the electrodes, which thereby become inactive. Hence, the practical capacities being obtained can generally be well below the theoretical capacity, in the order of 300 to 1000 mAh.g⁻¹ (the theoretical capacity being in the order of 1675 mAh.g⁻¹).

Thus, there is a need for improvements as regards the architecture of accumulators, for example, at the sulphur-based positive electrode, the electrolyte, the separator and the negative electrode.

From the structural point of view, a lithium/sulphur accumulator conventionally comprises at least one electrochemical cell including two electrodes based on different materials (a positive electrode comprising, as an active material, elemental sulphur and a negative electrode comprising, as an active material, metal lithium), between which an organic liquid electrolyte is disposed.

As regards the positive electrode containing sulphur, it is conventionally obtained by a coating process on a substrate which is the current collector, to yield a whole formed by two parts consisting of the current collector and the positive electrode as such. More specifically, an ink comprising a solvent, the active material, a carbon material (to improve the overall electron conductivity of the electrode) and a binder is firstly made. The ink is secondly deposited, on a substrate for being the current collector, which is, generally, a metal sheet (as an aluminium foil). After solvent evaporation and drying, a sulphur electrode deposited on a current collector is thus obtained, the resulting assembly being then incorporated in a cell comprising a separator impregnated with an organic liquid electrolyte, a negative electrode, the negative electrode and the positive electrode being disposed on either side of the separator. The sulphur percentage in the electrode is generally significant, generally from 50 to 90% and, preferentially, higher than 70% mass, so as to obtain accumulators with a strong energy density.

The discharge mechanism of a lithium-sulphur accumulator using such a positive electrode has first a step of dissolving the active material, which causes a collapse of the initial structure of the porous electrode because of an important sulphur percentage in the electrode. After dissolving the sulphur, the electrode porosity is such that the structure cannot be maintained and collapses. The available electrode area is thus decreased, and grains of material, or of carbon/binder composite, can be unsecured from the support consisting of the current collector. This damage, and resulting active area loss, turn out to be crucial at the end of discharge, because the species formed (Li₂S₂, Li₂S, . . . ) are both very insulating and insoluble in the organic electrolyte. Consequently, they precipitate at the positive electrode and are responsible for its progressive passivation. But, the thickness of material deposited being limited to a few nanometres (Li₂S being insulating and thus passivating), the deposition of a significant amount of active material thus depends on the available electrode conductive specific area.

In addition, the final discharge compound Li₂S is twice more voluminous than sulphur, which can also contribute to spraying the positive electrode structure at the end of discharge. In conclusion, the active material dissolution/precipitation cycles, inherent to the discharge mechanism, are thus responsible for the low practical capacitance restored and the low cycling life of the lithium-sulphur accumulators.

To attempt to solve this problem, and in particular that relating to the separation between the positive electrode and the current collector substrate, it has been suggested to use as a current collector a porous fabric, in which the active material is deposited.

Thus, document WO 2007/118281 describes an electrode architecture for electrochemical storage devices, in which the current collector consists of a substrate of fabric, on which an electrode ink, containing the active material, is applied. This embodiment imposes to use a pre-existing and generally commercially available current collector. What is more, because of its fabric composition, the current collector is heavier, for example, than a collector of aluminium, which causes a decrease in energy density.

Additionally, document WO 2012/038634 describes a process for manufacturing positive and negative electrodes with a porosity between 70% and 85% by depositing an ink containing the active material and having as a binder poly(acrylic acid) on a fabric of carbon fibres. The same drawbacks as those described in document WO 2007/118281 are found herein.

In view of what exists, the authors of the present invention have thus suggested to develop a new process for preparing a structure comprising a positive electrode for a lithium-sulphur battery, which enables, in particular, the use of a distinct current collector to be dispensed with.

### DISCLOSURE OF THE INVENTION

Thus, the invention relates to a process for preparing a structure both acting as a positive electrode for a lithium-sulphur battery and a current collector comprising the following operations of:
depositing one or more liquid compositions comprising the components of this structure onto a removable substrate;
drying the composition(s) deposited;
separating the removable substrate from the structure thus obtained, which is the structure both acting as a positive electrode for a lithium-sulphur battery and a current collector.

Advantageously:
when the structure is for being part of the composition of a lithium-sulphur accumulator operating in a “catholyte” type configuration, the depositing consists in depositing onto the removable substrate a single liquid composition comprising the components of said structure; or
when the structure contains a sulphur active material therein, the depositing consists in depositing onto the removable substrate a single composition comprising the components of said structure, including, in this case, a sulphur active material; or
when the structure contains a sulphur active material therein, the depositing consists in depositing onto the removable substrate a first composition comprising the components of said structure except for the sulphur active material and a second composition comprising the sulphur active material, wherein a drying can be interposed between both compositions deposited; or
when the structure contains a sulphur active material therein, the depositing consists in depositing onto the removable substrate a composition comprising the components of said structure except for the sulphur active material, the sulphur active material being introduced into the structure after separating the removable substrate.

The process of the invention, because of its flexibility, can provide the following advantages:
possibility, thanks to the choice of the ingredients, to adjust the morphology of the final structure being obtained, in order to achieve the best compromise between electrode porosity and available area for depositing species at the end of discharge, thus causing an improvement in the practical capacity restored;
possibility to adjust the rigidity of these structures, still by virtue of a judicious choice of ingredients, in order to provide a mechanical strength to the positive electrode, such that the amount of material deposited at each end of discharge can be constant, thus improving the behaviour during charge-discharge cycles;
dispensing with commercial media, for being the current collector, which brings an advantage in terms of cost and energy density; and
high production speed and possibility to easily change the electrode geometry, by varying in particular the geometry of the removable substrate, which acts as a depositing substrate.

Regardless of the specific modalities of the process, the components of said structure can be the following ones:
at least one inorganic carbon additive, which can provide, in addition to various functions, the current collector function;
at least one polymeric binder;
optionally, at least one sulphur active material, in particular, when the electrode is for a battery not operating on the catholyte mode (which means that the sulphur active material is contained in the electrolyte for contacting the electrode).

As regards the inorganic carbon additives, they can be chosen from carbon fibres, carbon powders and mixtures thereof.

By way of examples of carbon fibres, milled carbon fibres, carbon fibres obtained in vapour phase and mixtures thereof can be mentioned.

The milled carbon fibres can have in particular a length ranging from 100 μm to 1 mm.

The carbon fibres obtained in vapour phase can be those sold under the brand name VGCF®.

The carbon fibres used have, advantageously, a lower length than that of fibres commonly used in the traditional processes for making woven or non-woven fabrics (which fibres have a length in the order of a few mm). They enable the mechanical strength to be adjusted and provide electron percolation within the structure.

The carbon powders can, more specifically, correspond to carbon black, such as carbon black sold under the brand names Ketjenblack® (AzkoNobel), Vulcan® (Cabot), Super-P® (Timcal).

The carbon powders and optionally the carbon fibres obtained in vapour phase enable the electron conductivity to be improved and are responsible for the morphology of the electron percolation network.

The polymeric binders can be, for example:
polymeric binders belonging to the cellulosic polymer category, such as carboxymethylcellulose (known as the abbreviation CMC), methylcellulose (known as the abbreviation MC);
binders belonging to the fluorinated ethylenic polymer category, such as polytetrafluoroethylene (known as the abbreviation PTFE);
binders belonging to the vinylic polymer category, such as a poly(vinyl alcohol) (known as the abbreviation PVA); and
mixtures thereof.

The polymeric binders can have several roles:
they increase cohesion between the different ingredients of the structure and in particular the carbon additives;
in the composition(s), they enable ink viscosity to be adjusted.

More specifically, when it is PTFE, it can play the role of a film forming agent, and ensure mechanical strength of the final structure.

Finally, possibly, the sulphur active material can be elemental sulphur (S₈) or lithium disulfide (Li₂S).

The composition(s) mentioned in step a), can comprise at least one surfactant (such as those marketed under the brand names SDS®, Triton®) and, possibly, a pore forming material (such as that marketed under the brand name)AZB®.

The surfactants enable dispersion of carbon particles to be improved and the pore forming materials enable the porous structure obtained to be adjusted.

When a composition for being used in step a) comprises, all of carbon fibres, carbon powder, a polymeric binder, a surfactant and possibly a pore forming material, the proportions of these ingredients in the composition can be the following ones:
from 35 mass % to 80 mass % for the carbon fibres;
less than 35 mass % for the carbon powders;
from 5 to 30 mass % for the polymeric binder;
from 8 to 10 mass % for the surfactant; and
less than 10 mass % for the pore forming material,

the mass percentage being expressed with respect to the total mass of the ingredients.

According to a first advantageous embodiment, when the electrode is for operating in a catholyte type configuration, the depositing can consist in depositing on the removable substrate a single liquid composition comprising the components of said structure, such as those mentioned above, with the proviso that these ingredients do not contain a sulphur active material, insofar as it is fed via the electrolyte for being in contact with the structure, once the same is assembled in a lithium-sulphur accumulator cell.

According to a second embodiment, when the structure contains a sulphur active material therein, the process of the invention can include several alternatives.

According to a first advantageous alternative, the depositing can consist in depositing on the removable substrate a single composition comprising the components of said structure (including, in this case, a sulphur active material).

According to a second advantageous alternative, the depositing can consist in depositing on the removable substrate a first composition comprising the components of said structure except for the sulphur active material and a second composition comprising the sulphur active material, a drying can be interposed between both compositions deposited.

According to a third advantageous alternative, the depositing can consist in depositing on the removable substrate a composition comprising the components of said structure except for the sulphur active material, wherein the sulphur active material being introduced into the structure after separating the removable substrate, for example, by coating or sublimation.

Independently of the embodiments and alternatives provided, the process of the invention can comprise, after drying, a step of air sintering the structure obtained (in order, for example, to reinforce it) and/or a step of impregnating the structure obtained with a resin, for example a phenolic resin, followed by a step of carbonising the structure thus impregnated under a reducing atmosphere (for example an atmosphere comprising hydrogen alone or in mixture with a rare gas, such as argon), wherein this carbonising can occur at a temperature of 1,500° C.

Regardless of the embodiments and alternatives contemplated, the depositing of the liquid composition(s) can be contemplated by different techniques, such as:
dip-coating;
spin-coating;
laminar-flow-coating or meniscus coating;
spray-coating;
slip coating;
roll to roll process;
paint coating;
screen printing; or
techniques using a horizontal blade for deposition (known as “tape-coating”).

As regards the removable substrate, it is advantageously chosen to provide to the structure the desired shape. Concerning its chemical structure, it should advantageously be chosen so as to be inert to the components of the structure for being deposited on the same. By way of examples, the substrate can be of glass or polymeric material.

Regardless of the embodiments and alternatives contemplated, the process of the invention can comprise, upstream of depositing, preparing the composition(s) comprising the components of the structure, wherein this preparing can consist in contacting these ingredients and homogenising the mixture obtained, for example, with a mixer, such as a Dispermat.

The structures obtained according to the process of the invention are structures, because of the ingredients they contain, able to fulfil both the role of a positive electrode and the role of a current collector.

They are also self-supported structures, that is they do not require to be affixed to a support to be used in a lithium-sulphur accumulator.

They only form one and a single piece, that is they do not result from the admixing of a positive electrode and a current collector.

The invention also relates to structures acting both as a positive electrode for a lithium-sulphur battery and a current collector which are likely to be obtained by the process as defined above.

These structures advantageously comprise at least one inorganic carbon additive belonging to the carbon fibre category and at least one polymeric binder. Because of the presence of a polymeric binder, therefore, they consist of a composite material comprising a polymeric matrix, in which the other ingredients are dispersed. Therefore, they are not similar to an impregnated fabric as can be the case in prior art.

The carbon fibres and polymeric binders are similar to those described within the scope of the process of the invention.

More specifically, the carbon fibres can be carbon fibres obtained in vapour phase, milled carbon fibres and mixtures thereof.

More specifically, the polymeric binders can belong to the cellulosic polymer family, the fluorinated ethylenic polymer family and mixtures thereof.

Further, the structures of the invention can comprise a carbon powder, such as carbon black.

They can also include the other ingredients already mentioned above in the part relating to the description of the process of the invention.

The structures obtained according to the process of the invention are for being assembled in a lithium-sulphur accumulator comprising at least one cell comprising:
a structure acting as a positive electrode and a current collector which structure is obtained according to the process of the invention as defined above;
a negative electrode; and
a lithium-ion conducting electrolyte disposed between said structure and said negative electrode.

The following definitions are set out.

By positive electrode, it is conventionally meant, in what precedes and what follows, the electrode which acts as a cathode, when the accumulator feeds current (that is when it is in a discharge process) and which acts as an anode when the accumulator is in a charge process.

By negative electrode, it is conventionally meant, in what precedes and what follows, the electrode which acts as an anode, when the accumulator feeds current (that is when is in a discharge process) and which acts as a cathode, when the accumulator is in a charge process.

The negative electrode can be self-supported (that is not requiring to be affixed to a support, such as a current collector support) or can preferably comprise a current collector substrate on which at least the active material of the negative electrode is placed, wherein this active material can be advantageously metal lithium.

The current collector substrate can be of a metal material (comprised of a single metal element or an alloy of a metal element with another element), having, for example, the form of a plate or a foil, wherein an example specific to a current collector substrate can be a stainless steel or copper plate. The current collector substrate can also be of a carbon material.

The electrolyte is a lithium-ion conducting electrolyte, wherein this electrolyte can be, in particular, a liquid electrolyte comprising at least one organic solvent and at least one lithium salt.

The organic solvent(s) can be, for example, a solvent comprising one or more ether, nitrile, sulphone and/or carbonate functions with, for example, a carbon chain that can include from 1 to 10 carbon atoms.

By way of examples of solvents including a carbonate function, there can be mentioned:
cyclic carbonate solvents, such as ethylene carbonate (symbolised by the abbreviation EC), propylene carbonate (symbolised by the abbreviation PC).
linear carbonate solvents, such as diethyl carbonate (symbolised by the abbreviation DEC), dimethyl carbonate (symbolised by the abbreviation DMC), ethylmethyl carbonate (symbolised by the abbreviation EMC).

By way of example of solvents including an ether function, there can be mentioned ether solvents, such as 1,3-dioxolane (symbolised by the abbreviation DIOX), tetrahydrofuran (symbolised by the abbreviation THF), 1,2-dimethoxyethane (symbolised by the abbreviation DME), or an ether of the general formula CH₃O—[CH₂CH₂O],ₙ₋OCH₃ (n being an integer ranging from 1 and 10), such as tetraethyleneglycol dimethylether (symbolised by the abbreviation TEGDME) and mixtures thereof.

Preferably, the organic solvent is an ether solvent or a mixture of ether solvents.

The lithium salt can be chosen from the group consisting of LiPF₆, LiClO₄, LiBF₄, LiAsF₆, LiI, LiNO₃ LiR_{f}SO₃ (with R_{f} corresponding to a perfluoroalkyl group comprising from 1 to 8 carbon atoms), LiN(CF₃SO₂)₂(also called lithium bis[(trifluoromethyl)sulphonyl]imidide corresponding to the abbreviation LiTFSI), LiN(C₂F₆SO₂)₂ (also called lithium bis[(perfluoroethyl)sulphonyl]imidide corresponding to the abbreviation LiBETI), LiCH₃SO₃, LiB(C₂O₄)₂ (also called lithium bis(oxalato)borate or LiBOB) and mixtures thereof, most preferably a LiTFSI/LiNO₃ mixture.

The lithium salt can be present, in the electrolyte, at a concentration ranging from 0.25 M to 2 M, for example, 1 M.

Further, when the accumulator operates according to a catholyte configuration, the electrolyte can comprise at least one lithium polysulfide compound of the formula Li₂S, with n being an integer ranging from 2 to 8, such as Li₂S₆.

This compound thus is the sulphur source for the positive electrode.

In this case, the amount of lithium polysulfide compound introduced into the electrolyte is adapted as a function of the specific area of the structure obtained according to the process of the invention, that imposing the amount of the active material it is possible to deposit. For example, the lithium polysulfide compound can be dissolved in the electrolyte at a concentration ranging from 0.25 mol.L⁻¹ to the saturation concentration.

The electrolyte, when it comprises at least one lithium polysulfide compound as defined above, can be referred to as a “catholyte”.

In the lithium-sulphur accumulators, the abovementioned liquid electrolyte can be caused, in the electrochemical cells of lithium-sulphur accumulators, to impregnate a separator, which is disposed between the positive electrode and the negative electrode of the electrochemical cell.

This separator can be of a porous material, such as a polymeric material, able to accommodate the liquid electrolyte within its porosity.

The electrolyte can also be a gelled electrolyte, which corresponds, in this case, to an electrolyte comprising an organic solvent and a lithium salt, which are similar to those described above, which impregnates a porous matrix which swells by absorbing the electrolyte, wherein such a matrix can be a polyethylene oxide (known as the abbreviation POE), a polyacrylonitrile (known as the abbreviation PAN), a polymethyl methacrylate (known as the abbreviation PMMA), a polyvinylidene fluoride (known as the abbreviation PVDF) and derivatives thereof.

The invention will, now, be described in reference to particular embodiments defined below in reference to the appended figures.

### BRIEF DESCRIPTION OF THE FIGURES

FIG. 1 is a graph illustrating the potential E (in V) as a function of the capacity C (in a.u).

FIGS. 2-3 are photographs taken from above of the structures described in the experimental example 1.

FIG. 4 is a graph illustrating the potential E (in V) as a function of the specific capacity C (in mAh/gₛ) of the accumulators described in the experimental example 3.

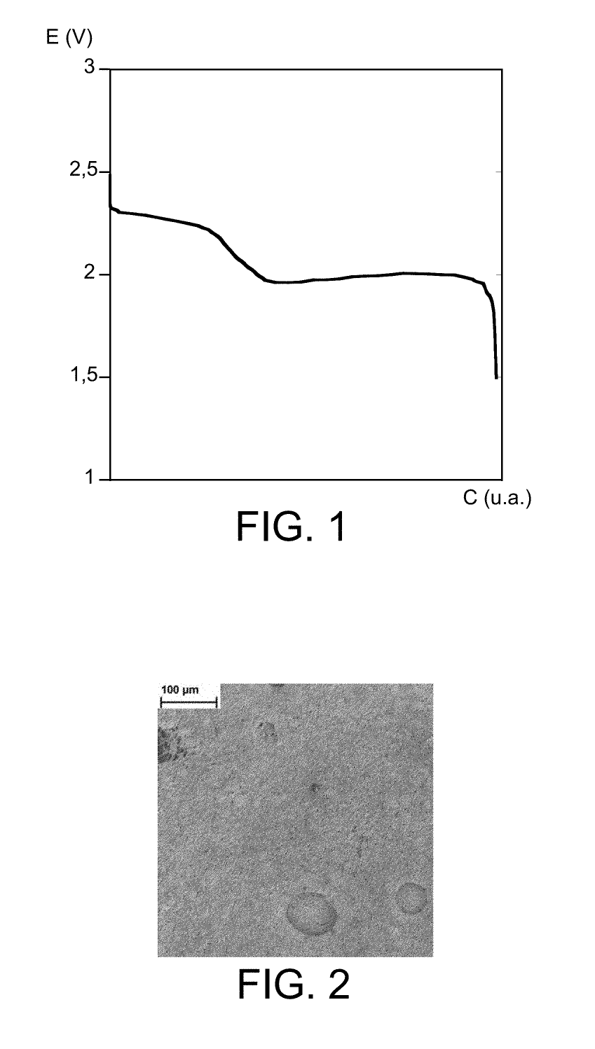

### DETAILED DISCLOSURE OF PARTICULAR EMBODIMENTS

### EXAMPLE 1

The present example illustrates the preparation of a structure obtained according to a process in accordance with the invention.

The composition used comprises the following ingredients:
39.72 g of methylcellulose as a 1.15 mass % water dispersion (10.60 mass % in the final structure);
3.4 g of carbon fibres obtained in vapour phase VGCF® (78.30 mass % in the final structure); and
0.8 g of a surfactant Triton® (11.10 mass % in the final structure).

The dry solid content (that is, the mass percentage of the dry product in the composition) is 9.89%.

The composition is mixed using a Dispermat (VMA) at 6000 rotations per minute for 30 minutes, is coated on a glass plate using a doctor blade (coating technology) and then dried at 80° C. in open air for 30 minutes.

The resulting structure is manually peeled off from the glass plate and dried at 95° C. under the air overnight.

### EXAMPLE 2

The present example illustrates the preparation of a structure obtained according to a process in accordance with the invention.

The composition used comprises the following ingredients:
39.72 g of methylcellulose as a 1.15 mass % water dispersion (8.80 mass % in the final structure);
2 g of carbon fibres obtained in vapour phase VGCF® (38.20 mass % in the final structure); and
1.4 g of carbon particles Vulcan® (27.80 mass % in the final structure);
1.23 g of a 60 mass % water PTFE dispersion (15 mass % in the final structure);
0.8 g of a surfactant Triton® (11.10 mass % in the final structure).

The dry solid content is 11.45%.

The composition is mixed using a Dispermat (VMA) at 6000 rotations per minute for 30 minutes, is coated on a glass plate using a doctor blade (coating technology) and then dried at 80° C. in open air for 30 minutes.

The resulting structure is manually peeled off from the glass plate and dried at 95° C. under the air overnight.

Finally, the resulting structure is sintered at 350° C. for 30 minutes under the air.

### COMPARATIVE EXAMPLE 1

A carbon non-woven felt (H2315V1, Freudenberg) has been bought to the manufacturer. It is rinsed with water and dried under the air at 95° C.

### EXPERIMENTAL EXAMPLE 1

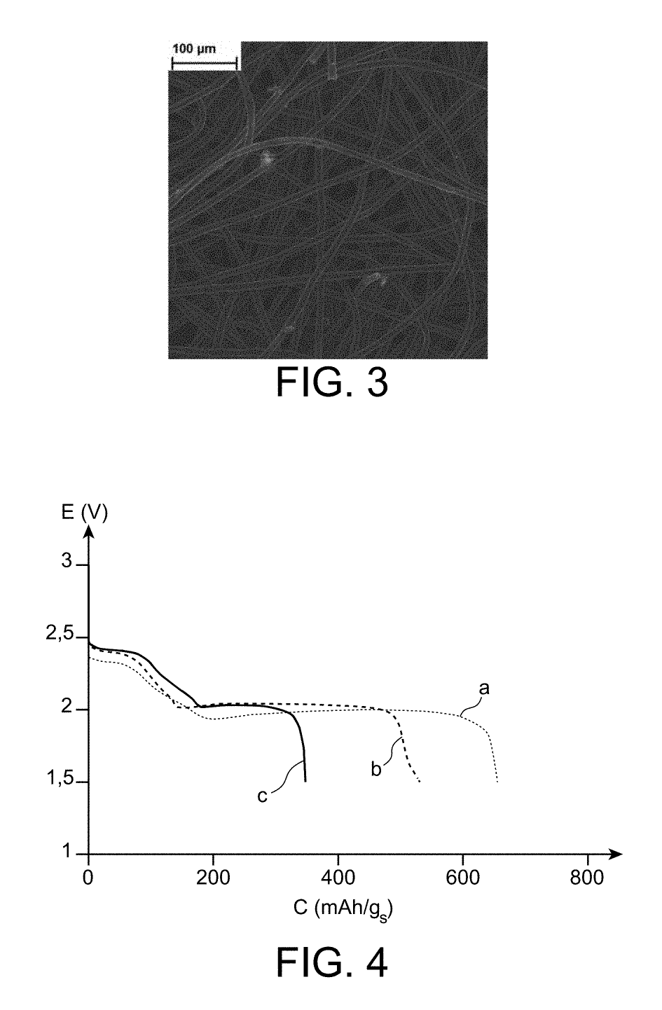

A scanning electron microscope (LEO 1530 FEG-SEM) has been used to obtain images of the structures obtained in the example 1 and comparative example 1. FIGS. 2 and 3 clearly show that the morphology and size of the pores of the structures obtained are influenced by the formulation and are differentiated from the commercial product (respectively FIG. 2 for the material obtained in the example 1 and FIG. 3 for the material obtained in the comparative example 1).

### EXPERIMENTAL EXAMPLE 2

The density value of the structures obtained in the examples 1, 2 and comparative example 1 has been determined, said density corresponding to the mass of the structure considered (obtained by weighing discs with a 14 mm diameter cut out in the structures obtained in said abovementioned examples) and its volume (obtained by measuring the dimensions of the disc using a micrometric gauge). The measurement has been repeated 10 times and its results are reported in Table 1 below.

The active area value has been obtained through a gas adsorption/desorption measurement at 77 K. The BET areas obtained are also reported in Table 1.

| Structure | Density (g · cm⁻³) | Active area (m² · g⁻¹) |
|---|---|---|
| Example 1 | 0.25 ± 0.05 | 7.12 ± 0.43 |
| Example 2 | 0.26 ± 0.01 (before sintering) | Not measured |
| | 0.19 ± 0.02 (after sintering) | |
| Comparative | 0.46 ± 0.01 | <Detection limit |
| example 1 | | |

### EXPERIMENTAL EXAMPLE 3

Discs with a 14 mm diameter have been cut out in the structures obtained in the examples 1, 2 and comparative example 1, and dried under vacuum (20 torr) at 80° C. for 48 hours. Then, they have been integrated, as a positive electrode, in a “button cell” type accumulator (CR2032) thus constructed:
a negative electrode of lithium with a 130 μm thickness, cut out at a diameter 16 mm and deposited onto a stainless steel disc acting as a current collector;
a positive electrode;
a Celgard® 2400 separator and a Viledon® separator, soaked with a liquid electrolyte based on the salt LiTFSI (1 mol.L⁻¹), LiNO₃(0.1 mol.L⁻¹) and Li₂S₆ (0.25 mol.L⁻¹) in solution in a 50/50 volume mixture of TEGDME (tetraethylene glycol dimethylether)—DIOX (Dioxolane).

The sulphur amount and the nominal capacity of the accumulator are respectively 7.20 mg (4.68 mgₛ.cm⁻¹) and 12.06 mAh.

After assembly, the accumulator thus made is sealed under an inert atmosphere and tested during a C/20 galvanostatic cycling.

The cycling curves of the accumulators made with the materials of the examples 1, 2 and comparative example 1 are presented in FIG. 4 (respectively curves a), b), c) for the accumulators made with the structures of the examples 1, 2 and comparative example 1) and in Table 2. The mass storage capacity is clearly influenced by the formulation used and the active area of the final structure, and is visibly improved by the use of the structures obtained in accordance with the process of the invention (≥600 versus≈400 mAh.g⁻¹ during the first cycle).

| | | | Comparative |
|---|---|---|---|
| Structure | Example 1 | Example 2 | example 1 |
| Mass | 560 | 530 | 200 |
| capacity (mAh · gₛ) | | | |
| at cycle 30 | | | |

What is claimed is:

1-16. (canceled)

17. A process for preparing a structure both acting as a positive electrode for a lithium-sulphur battery and a current collector comprising the following operations of:
depositing one or more liquid compositions comprising the components of this structure onto a removable substrate;
drying the composition(s) deposited;
separating the removable substrate from the structure thus obtained, which is the structure both acting as a positive electrode for a lithium-sulphur battery and a current collector,
wherein:
when the structure is for being part of the composition of a lithium-sulphur accumulator operating in a “catholyte” type configuration, the depositing consists in depositing onto the removable substrate a single liquid composition comprising the components of said structure; or
when the structure contains a sulphur active material therein, the depositing consists in depositing onto the removable substrate a single composition comprising the components of said structure, including, in this case, a sulphur active material; or
when the structure contains a sulphur active material therein, the depositing consists in depositing onto the removable substrate a first composition comprising the components of said structure except for the sulphur active material and a second composition comprising the sulphur active material, wherein a drying can be interposed between both compositions deposited; or
when the structure contains a sulphur active material therein, the depositing consists in depositing onto the removable substrate a composition comprising the components of said structure except for the sulphur active material, the sulphur active material being introduced into the structure after separating the removable substrate.

18. The process according to claim 17, wherein the components of said structure are the following ones:
at least one inorganic carbon additive;
at least one polymeric binder;
optionally, a sulphur active material.

19. The process according to claim 18, wherein the inorganic carbon additive is chosen from carbon fibres, carbon powders and mixtures thereof.

20. The process according to claim 19, wherein the carbon fibres are milled carbon fibres, carbon fibres obtained in vapour phase and mixtures thereof.

21. The process according to claim 19, wherein the carbon powders are carbon black.

22. The process according to claim 18, wherein the polymeric binder is chosen from:
polymeric binders belonging to the cellulosic polymer category;
binders belonging to the fluorinated ethylenic polymer category;
binders belonging to the vinylic polymer category; or
mixtures thereof.

23. The process according to claim 18, wherein the sulphur active material is elemental sulphur (S₈) or lithium disulfide (Li₂S).

24. The process according to claim 17, wherein the composition(s) mentioned in step a) comprise(s) at least one surfactant and, optionally, a pore forming material.

25. The process according to claim 17 further comprising, after drying, a step of air sintering the structure obtained and/or a step of impregnating the structure obtained with a resin followed by a step of carbonising the structure thus impregnated under a reducing atmosphere.

26. The process according to claim 17, wherein the removable substrate is of glass or of polymeric material.

27. A structure both acting as a positive electrode for a lithium-sulphur battery and a current collector likely to be obtained by the process as defined in claim 17.

28. The structure according to claim 27, which comprises at least one inorganic carbon additive belonging to the carbon fibre category and at least one polymeric binder.

29. The structure according to claim 28, wherein the carbon fibres are carbon fibres obtained in vapour phase, milled carbon fibres and mixtures thereof.

30. The structure according to claim 28, wherein the polymeric binder belongs to the cellulosic polymer family, the fluorinated ethylenic polymer family and mixtures thereof.

31. The structure according to claim 17, further comprising a carbon powder, such as carbon black.

32. A lithium-sulphur accumulator comprising at least one cell comprising:
a structure acting as a positive electrode and a current collector as defined in claim 27;
a negative electrode; and
a lithium-ion conducting electrolyte disposed between said structure and said negative electrode.
